(19) United States
(12) Patent Application Publication
(10) Pub. No.: US 2009/0053451 A1
(43) Pub. Date: Feb. 26, 2009

(54) DECORATIVE COVERINGS FOR ORTHOPEDIC SUPPORT

(76) Inventor: Jessica Smith, Boulder, CO (US)

Correspondence Address: MARSH, FISCHMANN & BREYFOGLE LLP, 8055 East Tufts Avenue, Suite 450, Denver, CO, 80237, US

(21) Appl. No.: 12/197,846

(22) Filed: Aug. 25, 2008

Related U.S. Application Data
(60) Provisional application No. 60/957,932, filed on Aug. 24, 2007.

(51) Int. Cl. B32B 38/10; B32B 33/00

(52) U.S. Cl. 428/42.1; 428/195.1; 156/289

(57) ABSTRACT

A decorative covering is provided for application to an exterior portion of an orthopedic support, Such an orthopedic support may be a cast made out of a curable resin impregnated fabric or any other orthopedic support known in the art. In one embodiment, the decorative covering may be formed on an at least partially translucent thermally deformable sheet member. In this embodiment a design layer may be printed on the sheet member such that the design layer makes up a decorative design. The sheet member may be applied to the orthopedic support using an adhesive applied to a side of the sheet member opposite the side on which the design layer is printed. Once initially adhered, the sheet member may be thermally deformed to at least partially conform to the contours of the underlying orthopedic support. In one embodiment, the sheet member has a pre-applied adhesive along with a release liner that covers the adhesive.

### CROSS-REFERENCE TO RELATED APPLICATION

This application claims priority and the benefit of the filing date under 35 U.S.C. 119 to U.S. Provisional Application No. 60/957,932, entitled, “DECORATIVE COVERINGS FOR ORTHOPEDIC SUPPORT,” filed on Aug. 24, 2007, the contents of which are incorporated herein as if set forth in full.

### FIELD OF INVENTION

The invention relates to decorative coverings (e.g. decals) that may be securely applied to the outside surface of an orthopedic cast or other orthopedic support (e.g., splint, brace etc.).

### BACKGROUND OF THE INVENTION

Historically, a number of different materials have been utilized to provide orthopedic support for patients who have broken bones or other injuries. For instance, plaster of paris casts were originally utilized for most broken bone applications. However, such plaster casts were typically heavy and did not allow a covered body portion to breath. Accordingly, most orthopedic casts now utilize synthetic casting materials, which are typically lightweight and strong. Further, such synthetic casting materials are also porous in a hardened state such that a resulting cast is breathable.

Such orthopedic synthetic casts are typically made from a curable resin impregnated narrow mesh fabric or casting tape. For instance, the fabric, which is typically knit, can be formed of glass fibers and/or synthetic fibers such as polyester, nylon and the like. When the synthetic casting materials are utilized, they may be removed from a sealed container and wetted. Once wetted, it may be applied to the patient, usually over a fabric (e.g., gauze) padding. The wetted casting material typically sets rapidly to a condition where it is capable of immobilizing the encased body part.

Recently, colored synthetic casting materials have become desirable from the standpoint of aesthetic appeal to the wearers of such orthopedic supports. Accordingly, prior to the application of the cast, many wearers are now given the opportunity to choose from several different colors for their cast. In addition, there have been several attempts to make casting materials (e.g. mesh tapes) that include patterns and/or designs such that, after they are applied to a patient, hardened casts includes designs or patterns that are included on the casting material.

In a further effort to make a cast more aesthetically pleasing, attempts have been made to utilize tubular coverings that are disposed over a cast. Such tubular coverings include those that are heat-shrinkable. In this regard, a user may place the tubular covering over the cast and heat-shrink the tubular covering into contact with the surface of the cast. However, such heat-shrink tubular coverings are typically formed of non-permeable (e.g., plastic) member that, once applied to the cast, prevents the cast from breathing.

### SUMMARY OF THE INVENTION

The present inventor has recognized that wearers of orthopedic supports (hereafter patients) often desire to individually decorate their supports/casts. However, due to the prevalence of the use of fibrous mesh casting materials, the surface of many such orthopedic supports are typically rough and uneven and applying decorations to the outside surface of the cast presents certain difficulties.

However, the present inventor has recognized that a combination of an adhesive-backed polymeric substrate (e.g., sheet member) and the application of heat may allow for securing decorations onto the surface of the rough/uneven textured surface of most synthetic cast materials as well as traditional materials (e.g., plaster of paris). In this regard, the present inventor has recognized that designs may be formed onto a non-adhesive surface of an adhesive sheet member. Once the designs are formed on the adhesive sheet member, a release liner may be removed from the adhesive sheet member, and the design may be applied to the outside surface of the cast. The adhesive on the adhesive sheet member may temporarily hold the design relative to the outside surface of the cast. However, due to the fibrous mesh surface of the cast, there remains little contact between the adhesive sheet member and the cast. However, by applying heat to the adhesive sheet member utilizing a heat source, the adhesive sheet member may drape into the pores between the fibrous mesh of the cast material such that contact between the adhesive sheet member and the cast member is substantially enhanced. What is, the heat may deform the sheet member such that it is at least partially received within the irregularities of the rough textured surface of the cast material.

Accordingly, once heated, the sheet member and the design formed on the sheet member are conformed to the surface of the cast member. Further, it will be appreciated that as the sheet member is draped into the individual pores of the fibrous casting material, the sheet member need not encircle a portion of the cast in order to maintain contact therewith. Accordingly, the sheet member may be cut to match an outside boundary of the design contained thereon. In this regard, it will be appreciated that, while the sheet member may not be permeable, the ability to put a number of small sheet members onto the cast allows remaining portions (e.g., non-covered portions) of the cast to remain breathable.

It has further been determined that it is typically desirable to utilize a substantially transparent or translucent sheet member such that portions of the sheet member that are not covered by the design allow the color of the underlying cast material to be seen. It has further been determined that in order for a design or image on the sheet member to be visible once applied to a colored cast material, it is desirable to initially print an opaque layer on the top surface of the sheet member and apply the design/image to the opaque layer. In one arrangement, a white base layer is applied. It has been found that absent such a base layer a design/image applied directly to the top of a transparent or translucent sheet member is minimally visible on the surface of a cast., especially colored casts Accordingly, once an opaque or white base layer is placed on the surface of the sheet member, any design/image color may be formed on top of the opaque or white base layer. Accordingly, these designs in combination with the base layer are highly visible when applied to the surface of the cast. Moreover, the substantially transparent or translucent sheet member allows the color of the cast material to show through portions not covered by the base layer and the design/image. These approaches to printing the design allow the design/image to appear as if the design was painted, air brushed, or otherwise applied directly to the surface of the cast. As such, a desirable artistic appearance to the design can be achieved through a process that many users can perform.

Also, the inventor has determined that the ability of the sheet member to resist peeling away from the support is severely degraded when sheet members having edges that form sharp comers are applied. That is, a sheet member with an edge that is gently curved as opposed to shaped to have a sharp point has greater adhesion resiliency and is less likely to peel away from the orthopedic support. However, many desirable designs include edges that are at sharp angles or otherwise undesirable shapes having a tendency to peel away from the support. The present inventor has realized that a translucent border partially or fully surrounding the design may provide the necessary curvature of the edge of the sheet member to prevent the sheet member from peeling away from the support. This can be done without changing the design to be printed, such that the design may take on any desired shape. Again, this translucent border allows the underlying color of the cast to show through, such that the border is minimally visible so that the border does not distract from the design, yet provides the requisite curving of the edge of the sheet member to help minimize the risk that the sheet member will lose contact between the sheet member and the support and peel away from the support.

In view of the foregoing, one aspect of the present invention is to provide a decorative covering for part of an exterior portion of an orthopedic support. Such an orthopedic support may be a cast made out of a curable resin impregnated fabric or any other orthopedic support known in the art. In one embodiment, the decorative covering may be formed on an at least partially translucent thermally deformable sheet member. In this embodiment a design layer may be printed on the sheet member such that the design layer makes up a decorative design. The sheet member may be applied to the orthopedic support using an adhesive applied to a side of the sheet member opposite the side on which the design layer is printed. Once initially adhered, the sheet member may be thermally deformed to at least partially conform to the contours of the underlying orthopedic support. In one embodiment, the sheet member has a pre-applied adhesive along with a release liner that covers the adhesive.

In one arrangement, an opaque backing layer may be applied to the sheet member prior to application of the design layer. In this regard, the opaque backing layer may correspond to the design layer such that the opaque layer is only applied to the sheet member where the design layer will be printed. This opaque backing layer may be white ink printed on the sheet member. The backing layer and design layer may be printed using any process known in the art. For example, a screen-printing process or an ink jet printing process may be employed. Additionally, different processes may be used for the opaque backing layer and the design layer, or the same process may be used.

In another arrangement, a translucent border is provided around at least a portion of the design of the decorative covering. This translucent border may be generated by printing the design layer or opaque base layer in an area smaller than the entirety of the sheet member. In this regard, the translucent border may extend fully around the outer edge of the design layer or may extend around a portion of the same. In another aspect of the present invention, the sheet member has and edge portion with a minimum radius of curvature, such that the edge's radius of curvature maintains a minimum value about the sheet member. Put another way, the edge of the sheet member in one aspect of the present invention is free of sharp corners.

In one arrangement the sheet member may have a minimum thickness of 15 mils. In another arrangement, the sheet member has a thickness of no greater than 5 mils. In yet another arrangement, the sheet member has a thickness of no greater than 3 mils.

In another aspect of the present invention, a method for producing a decorative covering for the exterior of an orthopedic support is contemplated. In one embodiment of this method, a design is selected that is desired to appear on the orthopedic support. This design may be digitized or otherwise stored. Also, the design may be one of an existing library of designs available to be applied to the decorative covering. Alternatively the design may be a custom picture selected by the patient. In the present embodiment, an opaque base layer is applied to a surface of an at least partially translucent sheet member. This opaque base layer may allow for the selected design to be more visible once the sheet member is applied to the support. The selected design is applied to the opaque base layer.

In one arrangement, the shape of the opaque base layer matches exactly the footprint shape of the design. However, this is not a requirement. The opaque base layer may extend to a greater or lesser area than the design. In one embodiment of the present invention, the base layer is white ink printed on the sheet member. The base and design layers may be printed using any method known in the art. In one embodiment of the present invention, a screen-printing method is used to print the base and design layers. Alternatively, other printing methods may be employed, including, without limitation, ink jet printing processes. In one arrangement, a substantially translucent border may at least partially surround the design. In another embodiment, the translucent border completely surrounds the design. This translucent border allows the edges of the sheet member to be radiused to help prevent the sheet member from peeling away from the support. As sheet members having edges with sharp bends and points increase the potential for the sheet to peel away from the support, a translucent border can allow for the proper curvature of the edge of the sheet with a variety of designs, including those with undesirable sharp bends and pointed features.

Another aspect of the present invention contemplates a method of applying a decorative covering to the exterior of an orthopedic support. This method may include removing a partially translucent sheet member from a backing layer, where the backing layer is disposed adjacent to the adhesive side of the sheet member. In this regard, the backing layer may serve to protect the adhesive or prevent adhesion to undesired surfaces. The backing layer and the sheet member may form a peel-and-stick type arrangement, such that once the sheet member is peeled from the backing layer it is ready to be applied. Once the backing layer has been removed, exposing the adhesive layer, the side of the sheet member with the adhesive is placed on the exterior of the support in a desired location. The sheet member is then heated to cause the sheet member to deform. This deformation causes the sheet member to sag or otherwise conform into the irregularities and pores of the support. In this regard, the surface area of the sheet member in contact with the support is increased, such that the adhesive on the sheet member comes into contact with a greater surface area once heated than prior to heating. This allows a more secure adhesive connection. Moreover, the sheet member may be further pressed into the irregularities of the support when still in the deformable state to further increase the amount of adhesion.

### BRIEF DESCRIPTION OF THE DRAWINGS

FIG. 1 illustrates an orthopedic cast as applied to a patient's appendage.

FIGS. 2A-2C illustrate a partial cross-sectional view of FIG. 1.

FIGS. 3A and 3B illustrate an adhesive backed design image in accordance with aspects of the present invention.

FIG. 4 illustrates the application of the design image of FIG. 3A to a cast.

FIG. 5 illustrates a process flow sheet for applying a design or image to an adhesive sheet member.

FIG. 6 illustrates a process flow sheet for applying a design to a cast member.

### DETAILED DESCRIPTION

The present invention will now be described in relation to the accompanying drawings. Though discussed primarily for use in application to orthopedic casts, it will be appreciated that aspects of the present invention are also applicable to orthopedic support devices and such application is considered within the scope of the present invention.

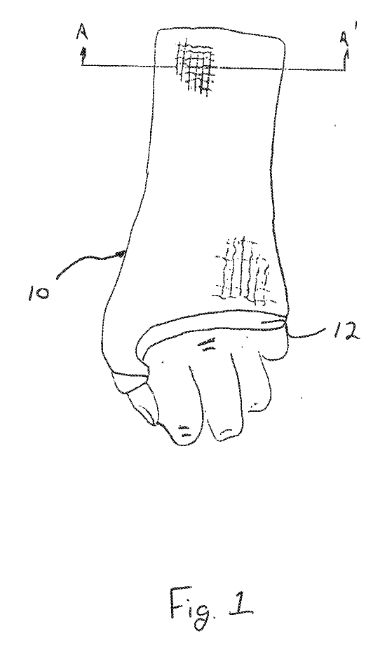

FIG. 1 illustrates an orthopedic cast 10 as applied to the appendage of a patient. As shown, the orthopedic cast has a rough-textured surface as it is formed from a synthetic mesh fabric. Typically, such synthetic cast material is formed from a curable resign impregnated mesh fabric or casting tape. Such fabric/casting tape may be formed of glass fibers, polyester, nylon, etc. In any case, the casting material is typically wetted and applied over a gauze layer 12 that is wrapped around a patient's appendage prior to application of the casting material.

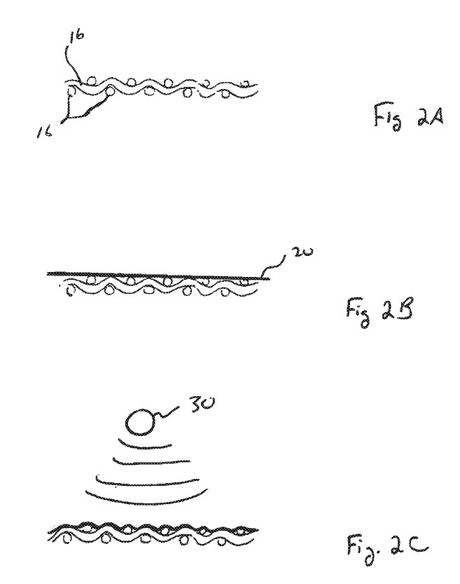

FIG. 2A illustrates a partial cross-sectional view taken along section lines AA of FIG. 1. As shown, individual fibers 16 of the cast material may form a weaved surface. As will be appreciated, this surface is typically rough and uneven. That is, between individual fibers, there may be pores/depressions. Accordingly, the application of an adhesive sheet member to the surface of such a cast fabric provides few points of contact. FIG. 2B, illustrates an adhesive sheet member 20 is applied to the top surface of the weaved fabric. As shown, the sheet member 20 has limited contact area between the fibers in the casting material. Accordingly, application of such an adhesive sheet member to the surface of the cast by itself will not result in an effective interconnection between the sheet member and the underlying textured surface of the cast material. That is, the adhesive sheet member may readily be removed from and/or will fall off of the cast.

It has been determined that, if the sheet member is a material (e.g., polymeric, vinyl, etc.) that has the ability to deform upon the application of heat, the sheet member may be thermally conformed to the rough texture of the cast material and thereby provide enhanced surface area contact with the cast material. That is, an adhesive sheet member applied to the surface of the cast material and thermally deformed to the surface may form an effective connection therewith and thereby be able to remain in place for an extended period of time. For instance, as shown in FIG. 2C, a heat source 30 is applied to the sheet material 20 after it is applied to the surface of the cast material. Accordingly, the sheet material 20 is able to drape into the pores between individual fibers of the cast material and thereby provide an enhanced contact area between, for example, an adhesive bottom surface of the sheet member and the individual fibers within the casting material. Accordingly, this increased surface area contact between the sheet member and the casting material provides a secure interconnection between the sheet member 20 and the cast material.

Based on the recognition that it is possible to deform a thin polymeric sheet member at least partially into the pores/weave of a fabric mesh, it has been determined that various designs and/or images may be formed on a top surface of the sheet member such that those designs/images may be applied to the surface of an orthopedic cast 10.

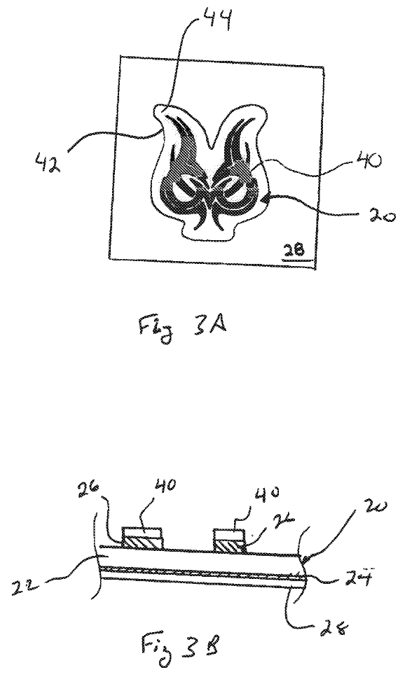

FIG. 3A illustrates a decorative design 40 that is applied to a top surface of an adhesive sheet member 20. In the present embodiment, the adhesive sheet member 20 is a substantially translucent sheet member such that areas of the sheet member 20 that are not covered by the design 40 allow the color of an underlying structure to show through. That is, when the design 40 is applied to the surface of an orthopedic cast, the underlying color of the cast may be seen through portions of the adhesive sheet member 20 that are not covered by the design 40. This creates a more realistic look to the design 40 such that it appears to have been airbrushed or otherwise artistically applied directly to the surface of the cast 10. Further, it will be noted that the cut line 42 forms a boundary 44 of the sheet member 20 that is removed from the edge of the design 40. Generally, this boundary is translucent to allow for the underlying color of the cast to be seen through the sheet member after application. This reduces the appearance of a hard edge between the design and the surface of the case sheet member. That is, the use of a partially translucent boundary 44 improves the appearance of the sheet member after application.

The use of a translucent boundary 44 around a portion or all of a design also serves another function. Specifically, the partially translucent boundary has a minimum radius of curvature. It has been determined that sheet members having sharp points tend to become unattached to underlying structures. Therefore, if the edges of sheet member exactly matched a design, the design may be limited to those having rounded edges. In this regard, use of the translucent boundary allows for producing designs that have sharp points that are surrounded by a translucent boundary having a rounded edge.

FIG. 3B illustrates a cross-sectional view of the sheet member 20. As shown, the sheet member 20 includes a base layer 22, which may be formed of a number of different polymeric materials including, without limitation, plastics and vinyls. A bottom surface of the base layer 22 is covered by an adhesive surface 24. This adhesive surface may be covered by a release liner 28. A top surface of the base layer may have designs and/or images formed thereon. Such formation of images on the top surface may be provided by any appropriate graphic application. In one arrangement, designs and/or images are printed onto the top surface of the base layer 22.

However, it has been determined that application of many colors directly to the top surface of the substantially translucent base layer 22 results in a design/image that is difficult to see when the sheet member 20 is applied to a colored surface of an orthopedic cast. In this regard, it has been determined that it is desirable to put an opaque backing layer on portions of the top surface of the base layer 22 that will be covered by the design 40. In one arrangement, the opaque backing layer 26 is a layer of white ink. Likewise, the design 40 may include any colored ink. However, use of the opaque backing layer 26 allows for the design/image 40 formed on top thereof to be readily visible when applied to a colored surface such as an orthopedic cast. Moreover, the backing layer 26 may be applied to an area greater or lesser than the final design to achieve a desired effect such as a design border or a blending effect.

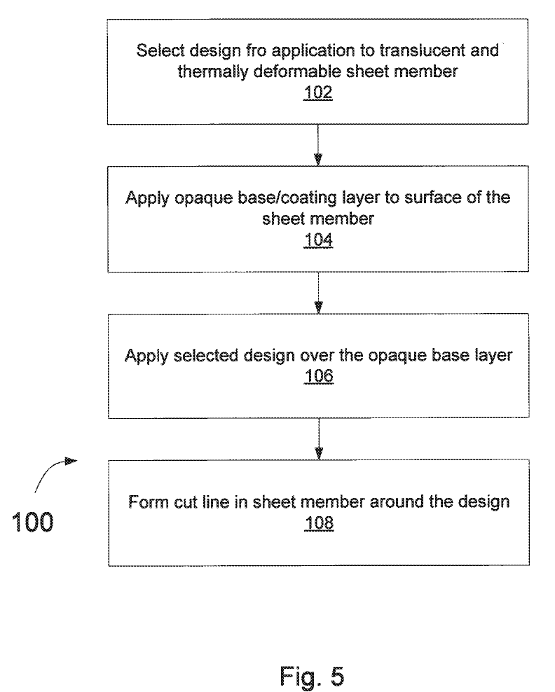

FIG. 5 generally illustrates a process 100 for use in forming a design 40 on the surface of a translucent and thermally deformable sheet member 20. Initially, a design or image is selected 102 for application to the sheet member. In this regard, it will be appreciated that any design or image that may be digitized may be utilized in a printing process. Accordingly, this may allow individuals to select a design or image they desire for use in decorating their orthopedic support. It will be appreciated that, medical facilities may have printing capabilities that allow for generation of sheet members 20 at the medical facility. In other arrangements, a patient may send (e.g., electronically via e-mail etc.) a desired design and/or image to a manufacturer of the sheet members and receive individualized sheet members for use in decorating their support. For instance, a patient may send an x-ray image of their broken bone.

In any case, during the process of forming the design/image on the surface of the sheet member, an opaque coating is applied 104 to the top/non-adhesive surface of the sheet member/membrane. It will be appreciated that the sheet member need not be translucent and may include sheet members of any desired colored. It may be desirable that the opaque coating layer be applied to the sheet member in the exact dimensions as the subsequent design or image. In this regard, once the design or image is applied 106 on top of the opaque coating layer, this opaque coating layer is not visible when the sheet member is applied to the orthopedic support. A cut line may then be formed 108 (or may be preformed) around the design. More typically, this cut line may be formed a distance away from the edge of the design in order to provide the translucent boundary as discussed above.

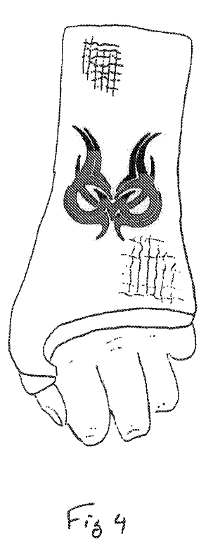

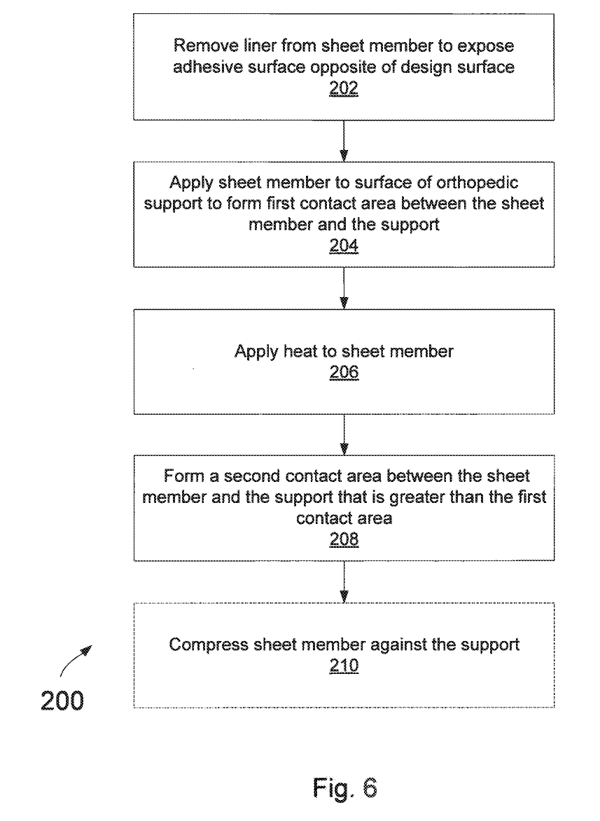

FIG. 6 illustrates a process 200 for applying an adhesive sheet, member including a design or image to the surface of an orthopedic cast. FIG. 4 illustrates the design illustrated in FIG. 3A as applied to the surface of an orthopedic cast. Initially, a design/image 40 is removed 202 from a backing layer 28 in order to expose an adhesive bottom surface thereof. This adhesive surface may then be applied 204 to a desired location on an orthopedic cast. Due to the limited contact between the bottom adhesive surface and the generally rough, uneven surface of the orthopedic cast, the user/patient may smooth the sheet member 20, including the design/image 40, to the cast member to remove any wrinkles therein. Once correctly positioned on the cast a first contact area is formed between the sheet member and the cast. A user/patient may then apply heat 206 from a heat source 30 to the top surface of the sheet member 20. In one arrangement, such a heat source may incorporate the use of a forced convective heat source such as, for example, a blow dryer. However, it will be appreciated that other heat sources, including radiant and conductive heat sources, may be utilized as well. What is important is that the heat source allows for the generally thin sheet member to drape into the pores between individual fibers of the cast surface to form 208 a second contact area. Accordingly, once the sheet member and design/image 40 have draped into the pores, the heat source may be removed. Further, to form the second contact area, a user may compress 210 the heated sheet member to against the cast material and/or into the pores.

Upon applying the heat to the sheet member and design/image 40 such that the sheet member is conformed to the uneven rough surface of the cast, a secure adhesive connection between the sheet member 20 and the underlying cast 10 is achieved. Furthermore, as the design/image 40 is draped into the individual pores of the cast material, the design/image may take on an almost airbrushed appearance. That is, the image may look as if it has been applied to the cast as opposed to simply sitting on the surface of the cast.

While securely interconnected to the surface of the cast member, it will be further appreciated that heating of the sheet member 20 does not result in the sheet member dissipating. In this regard, it is still possible to remove the sheet member 20 and design 40 from the cast if so desired. That is, a user/patient may grasp an edge of the sheet member (e.g., using tweezers) and gently work the sheet member 20 from the surface of the cast 10. it will be appreciated that any appropriate polymeric adhesive sheet member may be utilized. Further, it will be appreciated that sheet members that do not have an adhesive surface may be utilized as well. In such applications, the draping of the pliable sheet member into the pores upon application of heat to the sheet member may alone allow for forming an effective interconnection therebetween. Further, an adhesive may be applied to the bottom surface of a sheet member prior to application.

In order for the sheet member to deform into the pores of the cast material, it is typically desirable that the sheet member have a thickness that is less than 15 mils. More preferably, it is desirable that the sheet member have a thickness that is less than 5 mils. A further and more preferable embodiment utilizes a sheet member having a thickness of less than 3 mils. In this regard, it will be appreciated that the sheet member must have a certain minimum thickness to allow for appropriate draping into the pores of the underlying cast material.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A decorative covering for application to an exterior portion of an orthopedic support, comprising:
an at least partially translucent thermally deformable sheet member including a first surface and a second surface;
a design layer applied over at least a portion of said first surface, said design layer forming a decorative design; and
an adhesive applied to said second surface, said adhesive operative to adhere said second surface to said exterior portion of said orthopedic support.

2. A decorative covering as set forth in claim 1, further comprising:
an opaque base layer between said design layer and said first surface.

3. A decorative covering as set forth in claim 2, wherein said opaque base layer is a layer of white ink.

4. A decorative covering as set forth in claim 1, further comprising:
a backing layer removably engaged with said adhesive.

5. A decorative covering as set forth in claim 1, further comprising:
an at least partially translucent border, wherein said at least partially translucent border at least partially surrounds said decorative design.

6. A decorative covering as set forth in claim 5, wherein said at least partially translucent border fully surrounds said decorative design.

7. A decorative covering as set forth in claim 1, wherein said at least partially translucent thermally deformable sheet member has a minimum thickness of 5 mils.

8. A decorative covering as set forth in claim 1, wherein said at least partially translucent thermally deformable sheet member has a minimum thickness of 3 mils.

9. A method of applying a decorative covering to at least part of an exterior portion of an orthopedic support, comprising the steps:
removing an at least partially translucent sheet member from a backing layer to expose an adhesive surface;
placing said adhesive surface at a desired location on said orthopedic support such that adhesive of said adhesive surface adheres forms a first contact area between said sheet member and said orthopedic support;
heating said at least partially translucent sheet, member such that said at least partially translucent sheet member at least partially conforms to surface irregularities of said orthopedic support.

10. A method as set forth in claim 9, wherein said heating forms a second contact area between said sheet member and said orthopedic support, wherein said second contact area is greater than said first contact area.

11. A method as set forth in claim 9, wherein said heating step is accomplished via conductive heating.

12. A method as set forth in claim 9, wherein said heating step is accomplished via convective heating using a heated air.

13. A method as set forth in claim 9, further comprising:
compressing said sheet member against said orthopedic support after heating said sheet member.

14. A method of producing a decorative covering for at least part of an exterior portion of an orthopedic support, comprising the steps;
selecting a design;
first applying an opaque base layer to a first surface of an at least partially translucent and thermally deformable sheet member, said sheet member having an adhesive coating on a second surface;
second applying said design to said opaque base layer;
forming a cut line in said sheet member around said design, wherein at least a portion of said cut line is disposed a lateral distance from an edge of said design to form a translucent boundary between said edge and said cut line.

15. A method as set forth in claim 14, wherein said translucent boundary extends entirely around a periphery of said design.

16. A method as set forth in claim 14, wherein first applying an opaque base layer comprises applying a layer of white ink.

17. A method as set forth in claim 14, wherein said first and second applying steps are performed in an inkjet printing process.

18. A method as set forth in claim 14, wherein said first and second applying steps are performed in a screen printing process.
